(19) United States
(12) Patent Application Publication
(10) Pub. No.: US 2005/0149655 A1
(43) Pub. Date: Jul. 7, 2005

(54) Bus allocation method and apparatus

(75) Inventors: Young-jin Park, Bucheon-si (KR); Kyu-sung Kim, Yong-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/007,166

(22) Filed: Dec. 9, 2004

(30) Foreign Application Priority Data
Jan. 7, 2004 (KR) 2004-00883

(51) Int. Cl. G06F 13/00

(52) U.S. Cl. 710/104; 710/306

(57) ABSTRACT

A bus allocation method and apparatus are provided. A bridge receives a request to access a particular slave connected to a second bus from a K-th master among first through M-th masters connected to a first bus and transmits master identification information indicating that a master transmitting the request to access the particular slave is the K-th master to an arbiter connected to the second bus and manages the second bus. The arbiter receives a bus allocation request demanding allocation of the second bus from the bridge, and determines a bus allocation priority for the second bus that is given to the K-the master corresponding to the master identification information by using bus allocation information including bus allocation priorities for the second bus that are given to masters connected to the second bus and the bridge. The bridge accesses the particular slave according to the determined bus allocation priority.

### CROSS-REFERENCE TO RELATED APPLICATION

This application claims the benefit under 35 U.S.C. § 119(a) of Korean Patent Application No. 2004-883, filed on Jan. 7, 2004, in the Korean Intellectual Property Office, the entire disclosure of which is incorporated herein in its entirety by reference.

### BACKGROUND OF THE INVENTION

1. Field of the Invention

The present invention relates to master-slave access among different buses. More particularly, the present invention relates to a method and apparatus for determining a bus allocation priority for a bridge connecting buses.

2. Description of the Related Art

FIG. 1 is an exemplary diagram illustrating a bridge that connects different buses and masters and arbiters that are connected to the buses. Referring to FIG. 1, masters A1, A2, and A3 (12, 14, and 16) are connected to bus A 10. Masters B1, B2, and B3 (52, 54, and 56), slave B 58, and arbiter 60 are connected to bus B 50. In addition, a bridge 30 connects the bus A 10 and the bus B 50.

The bridge 30 functions to interface data between the bus A 10 and bus B 50. In other words, the bridge 30 is a device connecting buses using different protocols.

The arbiter 60 manages bus allocation to the masters B1, B2, and B3 (52, 54, and 56) and the bridge 30 that are connected to the bus B 50. To manage the bus allocation, the arbiter 60 has bus allocation information including a bus allocation priority of each of the masters B1, B2, and B3 (52, 54, and 56) and the bridge 30. Table 1 shows an example of bus allocation information for the bus B 50.

TABLE 1

| Devices on bus B | Bus allocation priorities |
|---|---|
| Master B1 | First priority |
| Master B2 | Second priority |
| Bridge | Third priority |
| Master B3 | Fourth priority |

The bus allocation priorities included in the bus allocation information may be permanently fixed or may be circulated periodically. Where the bus allocation priorities are fixed, the bus allocation information is a fixed type. Where the bus allocation priorities are circulated, the bus allocation information is a round robin type. Where the bus allocation information is the fixed type, the bus B 50 is primarily allocated to the master B1 52 whenever the master B1 52 accesses the slave B 58. However, where the bus allocation information is the round robin type, the bus allocation priorities shown in Table 1 are not fixed but circulated. For example, after the bus B 50 is primarily allocated to the master B1 52 accessing the slave B 58, the master B1 52 is given the fourth priority. In this situation, the master B2 54 having the second priority is given the first priority, the bridge 30 having the third priority is given the second priority, and the master B3 56 having the fourth priority is given the third priority. Accordingly, when the master B1 52 newly accesses the slave B 58 after bus B 50 was primarily allocated to the master B1 52, the bus B 50 is allocated to the master B1 52 in the fourth turn after being sequentially allocated to the master B2 54, the bridge 30, and the master B3 56 according to the circulated bus allocation priorities.

The following description concerns a method by which a device connected to one bus accesses another device connected to another bus. For example, where the master A1 12 connected to the bus A 10 requests an access to the slave B 58 connected to the bus B 50, data of the master A1 12 is transmitted to the bridge 30 through the bus A 10. Upon receiving the data, the bridge 30 requests the arbiter B 60 connected to the bus B 50 to allocate the bus B 50. In response to the bus allocation request from the bridge 30, the arbiter B 60 determines third bus allocation priority corresponding to the bridge 30 according to the bus allocation information. Where the bus allocation information is the fixed type, if the master B1 52 or the master B2 54 frequently requests allocation of the bus B 50, the bus B 50 can be allocated to the bridge 30 only after the bus B 50 is allocated to the master B1 52 or the master B2 54. Where the bus allocation information is the round robin type, the bridge 30 is sequentially given an increasing priority from the third priority to the second priority and the first priority, then is given the fourth priority, and then is given the third priority again, and this cycle is repeated. Accordingly, the bus B 50 is allocated to the bridge 30 according to changing priorities, and the bridge 30 transmits the data of the master A1 12 to the slave B 58 through the allocated bus B 50.

However, in a conventional method, where the master A1 12 needs to quickly access the slave B 58, when the bus allocation information is the fixed type, and the bridge 30 has a low bus allocation priority, it may take a long time for the master A1 12 to access the slave B 58. In other words, since the bridge 30 has the low bus allocation priority for the bus B 50, data transmission speed between buses is decreased as a whole. To overcome this problem, if a higher bus allocation priority is given to the bridge 30, the master A1 12 can quickly access the slave B 58. However, even devices, such as, the master A2 14 and the master A3 16, that do not need quick access to the slave B 58 may quickly access the slave B 58 through the bridge 30 because of a higher bus allocation priority for the bridge 30. As a result, the master B1 52 and the master B2 54 that need to access the slave B 58 more quickly than the master A2 14 and the master A3 16 may be hindered from quickly accessing the slave B 58.

The above-described problems also occur where the bus allocation information is the round robin type. In the round robin type, since a bus allocation priority given to the bridge 30 changes in a cycle, a low bus allocation priority may be given to the bridge 30 when a quick access is required, and thus the access is delayed. Conversely, a high bus allocation priority may be given to the bridge 30 when a quick access is not required, and thus accesses of other devices needing quick accesses are delayed.

Accordingly, there is a need for a bus allocation method and apparatus that quickly grants a master on a first bus access to a slave located on a second bus.

### SUMMARY OF THE INVENTION

The present invention provides a bus allocation method by which masters that are connected to one bus and access a slave connected to another bus are given different bus allocation priorities, respectively, for the other bus.

The present invention also provides a bus allocation apparatus which gives masters that are connected to one bus and access a slave connected to another bus different bus allocation priorities, respectively, for the other bus.

According to an aspect of the present invention, there is provided a bus allocation method including a bridge receiving a request to access a particular slave connected to a second bus from a K-th master among first through M-th masters connected to a first bus and transmitting master identification information indicating that the master transmitting the request to access the particular salve is the K-th master to an arbiter that is connected to the second bus and manages the second bus, wherein K is a positive integer greater than 1 and less than or equal to M and M is a positive integer greater than 1; receiving a bus allocation request demanding allocation of the second bus from the bridge, and determining a bus allocation priority for the second bus that is given to the K-th master corresponding to the master identification information by using bus allocation information including bus allocation priorities for the second bus that are given to masters connected to the second bus and the bridge; and the bridge accessing the particular slave according to the determined bus allocation priority.

According to another aspect of the present invention, there is provided a bus allocation apparatus including a master identification information generator for receiving a request to access a particular slave connected to a second bus from a K-th master among first through M-th masters connected to a first bus, generating master identification information indicating that a master transmitting the request to access the particular slave is the K-th master, and outputting the master identification information, wherein K is a positive integer greater than 1 and less than or equal to M and M is a positive integer greater than 1; and a bus allocation priority determiner for determining, in response to a bus allocation request demanding allocation of the second bus, a bus allocation priority for the second bus that is given to the K-th master corresponding to the master identification information by using bus allocation information including bus allocation priorities for the second bus that are given to masters connected to the second bus and the bridge, and outputting the determined bus allocation priority, wherein the bridge accesses the particular slave according to the determined bus allocation priority.

### BRIEF DESCRIPTION OF THE DRAWINGS

The above and other features and advantages of the present invention will become more apparent by describing in detail exemplary embodiments thereof with reference to the attached drawings in which:

FIG. 1 is an exemplary diagram illustrating a conventional bridge that connects different buses and masters and arbiters that are connected to the buses;

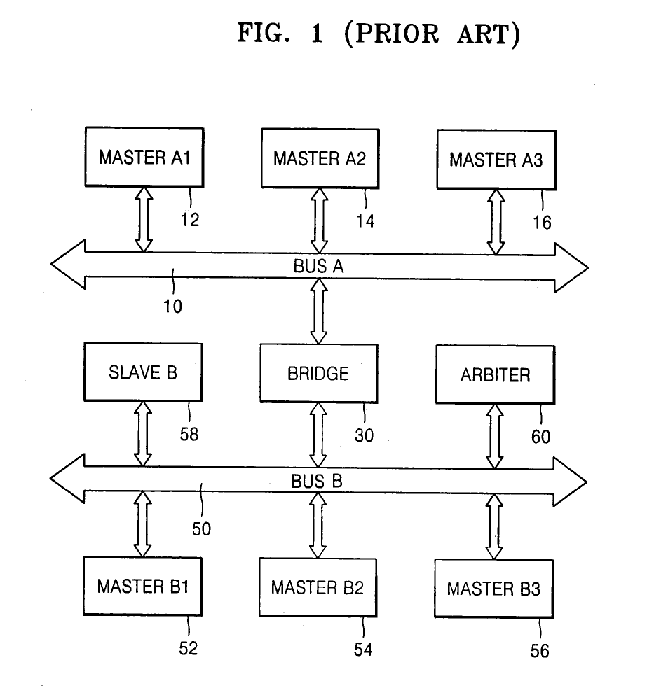

FIG. 2 is a flowchart of a bus allocation method according to an embodiment of the present invention;

FIG. 3 is an exemplary diagram illustrating a bridge that connects different buses, masters and arbiters that are connected to the buses, and an exclusive line that directly connects the bridge to the arbiters to explain the bus allocation method shown in FIG. 2; and

FIG. 4 is a block diagram of a bus allocation apparatus according to an embodiment of the present invention.

### DETAILED DESCRIPTION OF THE EXEMPLARY EMBODIMENTS

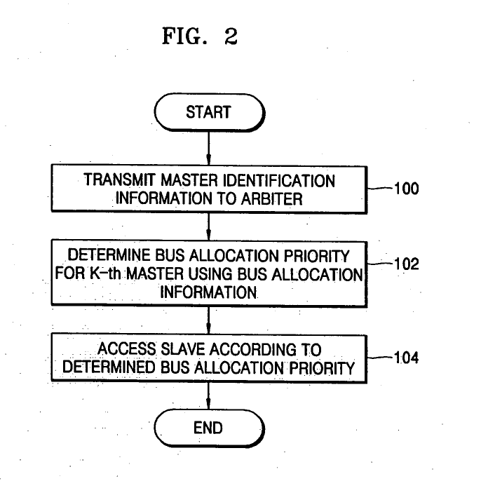

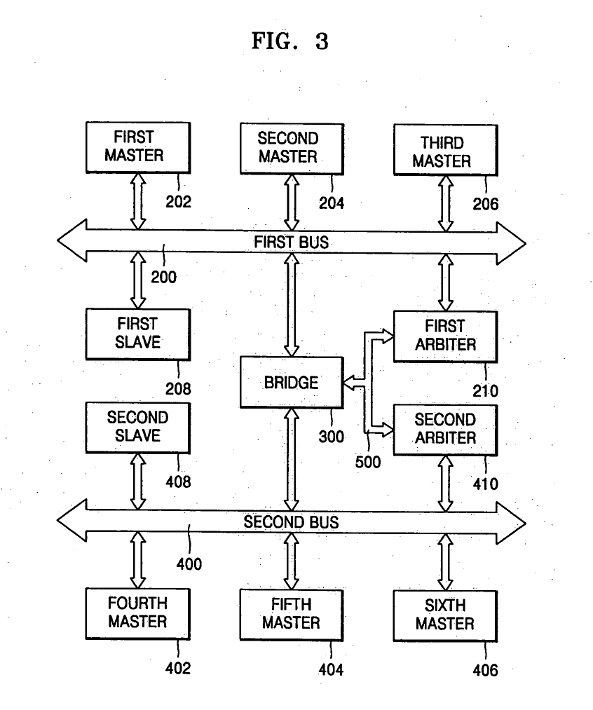

Referring to FIG. 2, a bus allocation method according to an embodiment of the present invention includes a bridge accessing a particular slave according to a predetermined bus allocation priority given for a K-th master in operations 100 through 104. FIG. 3 is an exemplary diagram illustrating a bridge that connects different buses, masters and arbiters that are connected to the buses, and an exclusive line that directly connects the bridge to the arbiters to explain the bus allocation method shown in FIG. 2.

When a bridge receives a request to access a particular slave connected to a second bus from the K-th master (where K is a positive integer greater than 1 and less than or equal to M) among first through M-th masters (where M is a positive integer greater than 1) connected to a first bus, the bridge transmits master identification information indicating that the master transmitting the request to access the particular slave is the K-th master to an arbiter that is connected to the second bus and manages the second bus in operation 100.

For example, referring to FIG. 3, when a bridge 300 receives a request to access a second slave 408 connected to a second bus 400 from a first master 202 among first through third masters 202, 204, and 206 connected to a first bus 200, the bridge 300 stores data received from the first master 202 and generates master identification information indicating that the master transmitting the request to access is the first master 202 among the first through third masters 202, 204, and 206. The bridge 300 generates unique master identification information distinctly identifying the first master 202 from among the first through third masters 202, 204, and 206 connected to the first bus 200 by analyzing the data received from the first master 202.

The bridge 300 transmits the master identification information regarding the first master 202 to a second arbiter 410 managing the second bus 400. The second arbiter 410 recognizes that the first slave 202 connected to the first bus 200 requests an access to the second slave 408 according to the master identification information. In order to quickly transmit the master identification information to the second arbiter 410 in real time, an exclusive line 500 is connected between the bridge 300 and the second arbiter 410. Since the exclusive line 500 directly connects the bridge 300 and the second arbiter 410, the master identification information can be quickly transmitted to the second arbiter 410 without passing through the second bus 400.

In another example, when the bridge 300 receives a request to access a first slave 208 connected to the first bus 200 from a fourth master 402 among fourth through sixth masters 402, 404, and 406 connected to the second bus 400, the bridge 300 stores data received from the fourth master 402 and generates master identification information indicating that the master transmitting the request to access is the fourth master 402 from among the fourth through sixth masters 402, 404, and 406.

The bridge 300 transmits the master identification information regarding the fourth master 402 to a first arbiter 210 managing the first bus 200. The first arbiter 210 recognizes that the fourth master 402 connected to the second bus 400 requests an access to the first slave 208 according to the master identification information. In order to quickly transmit the master identification information to the first arbiter 210 in real time, the exclusive line 500 is connected between the bridge 300 and the first arbiter 210.

Referring back to FIG. 2, after operation 100, the arbiter receives a bus allocation request demanding allocation of the second bus from the bridge, and determines a bus allocation priority for the second bus for the K-th master corresponding to the master identification information using bus allocation information including bus allocation priorities for the second bus that are given to the masters connected to the second bus and the bridge in operation 102. According to the bus allocation information, different bus allocation priorities are given to the first through M-th master connected to the first bus.

For example, when the first master 202 requests an access to the second slave 408, the bridge 300 receives the access request and data from the first master 202. When it is determined that the data is completely received, the bridge 300 transmits a bus allocation request for the second bus 400 to the second arbiter 410. The bus allocation request is a signal requesting the second arbiter 410 to permit use of the second bus 400.

Upon receiving the bus allocation request, the second arbiter 410 determines a bus allocation priority for the second bus 400 for the first master 202 corresponding to the master identification information using the bus allocation information provided in advance. The bus allocation information includes bus allocation priorities for the second bus 400 that are given to the fourth through sixth masters 402 through 406 connected to the second bus 400 and the bridge 300. Table 2 is an example of the bus allocation information.

TABLE 2

| Devices connected to the second bus | Bus allocation priorities | |
|---|---|---|
| Fourth master | Second priority | |
| Fifth master | Fourth priority | |
| Bridge | First master | First priority |
| | Second master | Third priority |
| | Third master | Sixth priority |

| | |
|---|---|
| Sixth master | Fifth priority |

Upon receiving the bus allocation request, the second arbiter 410 recognizes that the first master 202 is requesting allocation of the second bus 400 according to the master identification information and detects the first priority corresponding to the bus allocation priority given to the first master 202 from the bus allocation information shown in Table 2. The second arbiter 410 determines the detected first priority as a bus allocation priority given to the first master 202.

If the bridge 300 shown in FIG. 3 receives a request for an access to the second slave 408 from the second master 204, the bridge 300 receives an access request and data from the second master 204. If it is determined that the received data is complete, the bridge 300 transmits a bus allocation request for the second bus 400 to the second arbiter 410. If the bus allocation request is transmitted to the second arbiter 410, the second arbiter 410 recognizes based on the master identification information received in operation 100 that the second master 204 requests to allocate the second bus 400 and detects a third priority corresponding to a bus allocation priority given to the second master 204 using the bus allocation information shown in Table 2. The second arbiter 410 determines the detected third priority as the bus allocation priority given to the second master 204. In other words, in response to the request of the second master 204 for an access to the second slave 408, the third priority immediately below the second priority for the second bus 400 given to the fourth master 402 is given for the second bus 400 to the second master 204.

The bus allocation information may have bus allocation priorities fixed or circulated. Where the bus allocation information has fixed bus allocation priorities, the bus allocation priorities given to the fourth through sixth masters 402, 404, and 406 and the bridge 300 shown in Table 2 do not change. Where the bus allocation information has circulated bus allocation priorities, the bus allocation priorities given to the fourth through sixth masters 402, 404, and 406 and the bridge 300 shown in Table 2 circulate. For example, the bus allocation priority given to the fourth master 402 may change from the second priority to the fifth priority, the bus allocation priority given to the fifth master 404 may change from the fourth priority to the second priority, and the bus allocation priority given to the sixth master 406 may change from the fifth priority to the fourth priority. However, although the bus allocation information has circulated bus allocation priorities, the bus allocation priorities given to the bridge 300, i.e., the first through third masters 202, 204, and 206 are not circulated but are fixed.

The bus allocation information is stored in a predetermined storage space of the second arbiter 410 in advance. The bus allocation priorities included in the bus allocation information shown in Table 2 are just examples and may be changed by a manufacturer or a user.

Referring back to FIG. 2, after operation 102, the bridge accesses the particular slave according to the determined bus allocation priority in operation 104. For example, if it is determined that the first priority for the second bus 400 is given to the first master 202 in operation 102, the second bus 400 is allocated to the bridge 300 storing the data of the first master 202, and the bridge 300 accesses the second slave 408 through the second bus 400. In other words, the data stored in the bridge 300 can be transmitted to the second slave 408, and data stored in the second slave 408 can be transmitted to the bridge 300.

According to embodiments of the present invention, since different bus allocation priorities for the second bus 400 are given to the first through third masters 202, 204, and 206 that are connected to the first bus 200 and access the bridge 300, the first through third masters 202, 204, and 206 are allowed to access the second slave 408 connected to the second bus 400 with different time delays according to their degrees of necessity for quick access to the slave 408.

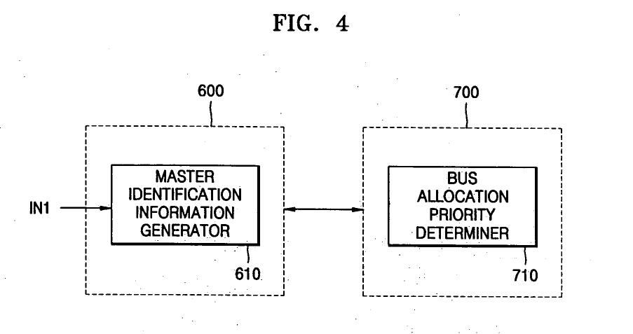

The following description describes a bus allocation apparatus according to an embodiment of the present invention. Referring to FIG. 4, the bus allocation apparatus according to the embodiment of the present invention includes a bridge 600 and an arbiter 700. The bridge 600 includes a master identification information generator 610, and the arbiter 700 includes a bus allocation priority determiner 710.

The bridge 600 connects a first bus and a second bus. The master identification information generator 610 receives a request to access a particular slave connected to a second bus from the K-th master (where K is a positive integer greater than 1 and less than or equal to M) among first through M-th masters (where M is a positive integer greater than 1) connected to a first bus, generates and outputs master identification information indicating that the master transmitting the request to access the particular slave is the K-th master. The master identification information generator 610 receives the request to access the particular slave connected to the second bus and data from the K-th master through an input terminal IN1. In response to the access request, the master identification information generator 610 generates the master identification information indicating that the master transmitting the access request is the K-th master and outputs the master identification information to the bus allocation priority determiner 710.

Meanwhile, to transmit the master identification information in real time, an exclusive line like the exclusive line 500 shown in FIG. 3 is provided between the master identification information generator 610 and the bus allocation priority determiner 710. Since the exclusive line is provided between the master identification information generator 610 and the bus allocation priority determiner 710, the master identification information generated by the master identification information generator 610 can be directly transmitted to the bus allocation priority determiner 710 of the arbiter 700 without passing through the second bus.

The arbiter 700 manages bus allocation priorities for the second bus that are given to a plurality of masters connected to the second bus and the bridge 600. In response to a bus allocation request for the second bus, the bus allocation priority determiner 710 determines a bus allocation priority for the second bus that is given to the K-th master corresponding to the master identification information using bus allocation information including the bus allocation priorities for the second bus that are given to the plurality of masters connected to the second bus and the bridge 600, and outputs the determined bus allocation priority. If the bridge 600 receives the data for the access to the particular slave from the K-th master, it outputs the bus allocation request for the second bus to the bus allocation priority determiner 710. In response to the bus allocation request, the bus allocation priority determiner 710 determines a bus allocation priority for the second bus that is given to the K-th master corresponding to the master identification information received from the master identification information generator 610 and outputs the determined bus allocation priority to the bridge 600.

The bus allocation information is characterized by different bus allocation priorities for the second bus that are given to the first through M-th masters connected to the first bus. The bus allocation information may include fixed or circulated bus allocation priorities. The details of the bus allocation information have been described above, and thus a description thereof will be omitted here.

Thereafter, the bridge 600 accesses the particular slave according to the bus allocation priority determined by the bus allocation priority determiner 710. In other words, the bridge 600 can transmit data stored therein to the particular slave through the second bus, and the particular slave can transmit data stored therein to the bridge 600 through the second bus.

As described above, according to a bus allocation method and apparatus of the present invention, masters that are connected to one bus and access a slave connected to another bus are given different bus allocation priorities, respectively, for the another bus, so that the masters can access the slave connected to the another bus with different time delays taking into account the masters' degrees of necessity of a quick access.

1. A method of allocating buses connected by a bridge, the method comprising:
receiving a request to access a particular slave connected to a second bus from among a plurality of buses from a K-th master among first through M-th masters connected to a first bus from among a plurality of the buses and transmitting master identification information indicating that a master transmitting the request to access the particular salve is the K-th master to an arbiter that is connected to the second bus and manages the second bus, wherein K is a positive integer greater than 1 and less than or equal to M and M is a positive integer greater than 1;
receiving a bus allocation request demanding allocation of the second bus from the bridge, and determining a bus allocation priority for the second bus that is given to the K-the master corresponding to the master identification information by using bus allocation information comprising bus allocation priorities for the second bus that are given to masters connected to the second bus and the bridge; and
accessing the particular slave according to the determined bus allocation priority.

2. The method of claim 1, wherein the bus allocation information comprises different bus allocation priorities given to the first through M-th masters, respectively, connected to the first bus.

3. The method of claim 2, wherein the bus allocation priorities comprised in the bus allocation information are fixed.

4. The method of claim 2, wherein the bus allocation priorities comprised in the bus allocation information are circulated.

5. The method of claim 1, wherein the master identification information is transmitted in real time through an exclusive line provided between the bridge and the arbiter.

6. An apparatus for allocating buses connected by a bridge, the apparatus comprising:
a master identification information generator for receiving a request to access a particular slave connected to a second bus from among the plurality of buses from a K-th master among first through M-th masters connected to a first bus from among the plurality of buses, generating master identification information indicating that a master transmitting the request to access the particular salve is the K-th master, and outputting the master identification information, wherein K is a positive integer greater than 1 and less than or equal to M and M is a positive integer greater than 1; and
a bus allocation priority determiner for determining, in response to a bus allocation request demanding allocation of the second bus, a bus allocation priority for the second bus that is given to the K-the master corresponding to the master identification information by using bus allocation information comprising bus allocation priorities for the second bus that are given to masters connected to the second bus and the bridge, and outputting the determined bus allocation priority,
wherein the bridge accesses the particular slave according to the determined bus allocation priority.

7. The apparatus of claim 6, wherein the bus allocation information comprises different bus allocation priorities given to the first through M-th masters, respectively, connected to the first bus.

8. The apparatus of claim 7, wherein the bus allocation priorities comprised in the bus allocation information are fixed.

9. The apparatus of claim 7, wherein the bus allocation priorities comprised in the bus allocation information are circulated.

10. The apparatus of claim 6, further comprising an exclusive line provided between the master identification information generator and the bus allocation priority determiner to transmit the master identification information in real time.
